(19) United States
(12) Patent Application Publication
(10) Pub. No.: US 2018/0060260 A1
(43) Pub. Date: Mar. 1, 2018

(54) METHOD AND DEVICE CAPABLE OF AUTOMATICALLY IDENTIFYING HOST OPERATING SYSTEMS

(71) Applicant: PROLIFIC TECHNOLOGY INC., Taipei City (TW)

(72) Inventors: TIEN-WEI YU, Taipei City (TW); CHUN-SHIU CHEN, Taipei City (TW)

(21) Appl. No.: 15/245,174

(22) Filed: Aug. 24, 2016

(51) Int. Cl. G06F 13/38; G06F 13/42

(52) U.S. Cl. CPC G06F 13/385; G06F 13/4282

(57) ABSTRACT

The present invention provides a method and a device capable of automatically identifying host operating system. For the conventionally-used USB devices or USB bridge interfaces cannot effectively identify all kinds of Operation Systems (OS) from an electronic device, the present invention proposes a novel USB device consisting of: a USB physical interface, a central processing unit, and at least one peripheral interface controller; wherein the central processing unit is particularly embedded with an OS identifying library. Moreover, the present invention simultaneously proposes an automatic OS identifying method, which particularly consists of a plurality of OS identifying steps designed based on conventional USB enumeration procedures. Thus, when a specific OS of a host device treats this novel USB device with a USB enumeration, the OS identifying library is able to detect the kind of the specific OS installed in the host device, according to the plurality of OS identifying steps.

### BACKGROUND OF THE INVENTION

### 1. Field of the Invention

The present invention relates to the technology field of USB devices, and more particularly to a method and a device capable of automatically identifying host operating systems.

### 2. Description of the Prior Art

Through the plug-and-play characteristic of universal serial bus (USB), desk computers or notebooks can easily expand their peripheral devices having an USB interface, such as mouse, keyboard, joystick, scanner, digital camera, printer, flash drive, portable external hard drive, optical drive, wireless network card, speaker, and microphone.

As engineers skilled in USB device designing and manufacturing technology field know, a specific operating system installed in a host electronic device would automatically treat a specific USB device with an USB enumeration procedure when the specific USB device is connected to the host electronic device. Taking Windows XP as the example of the operating system, wherein the USB enumeration procedure executed by Windows XP consists of following steps:
step (1′): initialing the USB device, and then setting a device address of the USB device as 0;
step (2′): requesting the USB device to reply a 64-byte length device descriptor;
step (3′): resetting the USB device, and then sending a “Set Address” command to the USB device so as to complete the address setting of the USB device;
step (4′): requesting the USB device to reply a 18-byte length device descriptor for obtaining foundational information of the USB device, such as VID (vender identification) and PID (product identification);
step (5′): requesting the USB device to reply a 9-byte length configuration descriptor for getting the number of interfaces of the USB device (bNumInterfaces);
step (6′): requesting the USB device to reply an interface descriptor, so as to know the number of end points of the USB device (bNumEndpoints);
step (7′): requesting the USB device to reply an endpoint descriptor for obtaining the data transmission mode of the endpoints (bmAttributes); and
step (8′): waiting for completing the driving of the USB device by USB device driving software.

Moreover, the engineers skilled in USB device designing and manufacturing technology field also know that, some of commercial USB devices just can support one specific operating system because the steps of USB enumeration procedure adopted by others operating system such as iOS or Android would be not completely identical to the above-listed steps (1′)-(8′). For instance, RNDIS (Remote Network Driver Interface Specification) is a Microsoft proprietary protocol implemented in a first USB network device, wherein the first USB network device merely supports Windows XP and other advanced Windows operating systems. On the other hand, CDC/ECM (Communications Device Class/Ethernet Control Model) is another one proprietary protocol implemented in a second USB network device, wherein the second USB network device merely supports the operating systems of Mac OS and Linux.

With the update and increase of USB interfaces' type, all operating systems including Microsoft's Windows, Apple's Mac OS and iOS, Google's Android, and Linus constantly upgrade their expandability on USB devices; nevertheless, USB devices or interfaces must simultaneously possess outstanding host operating system identifying ability in order to support all of the operating systems. In view of that, inventors of the present application have made great efforts to make inventive research thereon and eventually provided a method and a device capable of automatically identifying host operating systems.

### SUMMARY OF THE INVENTION

The primary objective of the present invention is to provide a method and a device capable of automatically identifying host operating system. For conventionally-used USB devices or USB bridge interfaces cannot identify all kinds of Operation Systems (OS) from an electronic device, the present invention proposes a novel USB device consisting of: a USB physical interface, a central processing unit, and at least one peripheral interface controller. In the present invention, the central processing unit is particularly embedded with an OS identifying library for facilitating the novel USB device identify all kinds of Operation Systems. Moreover, the present invention simultaneously proposes an automatic OS identifying method, which particularly consists of a plurality of OS identifying steps designed based on conventional USB enumeration procedures. Thus, when a specific OS of a host device treats this novel USB device with a USB enumeration, the OS identifying library is able to detect the kind of the specific OS installed in the host device, according to the plurality of OS identifying steps.

In order to achieve the primary objective of the present invention, the inventor of the present invention provides an embodiment for the method capable of automatically identifying host operating system, comprising following steps:
(1) connecting an USB device to a host electronic device installed with an operating system;
(2) determining whether the operating system sends an address setting command to the

USB device, if yes, proceeding to step (3); otherwise, proceeding to step (4);
(3) identifying the operating system as a first class operating system or a second class operating system, and then proceeding to an ending step;
(4) determining whether the operating system requests the USB device to reply a 18-byte length device descriptor, if yes, proceeding to step (5); otherwise, proceeding to step (6);
(5) identifying the operating system as a third class operating system, and then proceeding to the ending step;
(6) determining whether the operating system requests the USB device to reply a device descriptor having a specific byte length smaller than 8 bytes as well as the operating system requests the USB device to reply the device descriptor repeatedly, if yes, proceeding back to the step (4); otherwise, proceeding to step (8);
(7) identifying the operating system as a fourth class operating system, and then proceeding to the ending step;
(8) identifying the operating system as the second class operating system, and then proceeding to the ending step.

For achieving the primary objective of the present invention, the inventor of the present invention also provides an embodiment for the device capable of automatically identifying host operating system, comprising:
an USB physical interface, being used for connecting an USB unit of an external host electronic device; wherein the USB physical interface comprises an USB physical unit and an USB control unit embedded with an operating system (OS) identifying module;
a central processing unit, being coupled to the USB physical interface; and
at least on peripheral interface controlling unit, being coupled to the central processing unit;
wherein when an operating system installed in the host electronic device treats the USB device with an USB enumeration procedure, the OS identifying module being able to identify the operating system as a first class operating system, a second class operating system, a third class operating system, or a fourth class operating system based on an address setting command sent by the operating system, a device descriptor replied by the USB device, a configuration descriptor replied by the USB device.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo diagram of an USB device integrated with USB and wireless network technologies;

FIG. 2 shows a first circuit block diagram of a device capable of automatically identifying host operating system according to the present invention;

FIG. 3 shows a second circuit block diagram of the device capable of automatically identifying host operating system;

FIG. 4A and FIG. 4B show flow charts of a method capable of automatically identifying host operating system according to the present invention.

### DETAILED DESCRIPTION OF THE PREFERRED EMBODIMENTS

To more clearly describe a method and a device capable of automatically identifying host operating system according to the present invention, embodiments of the present invention will be described in detail with reference to the attached drawings hereinafter.

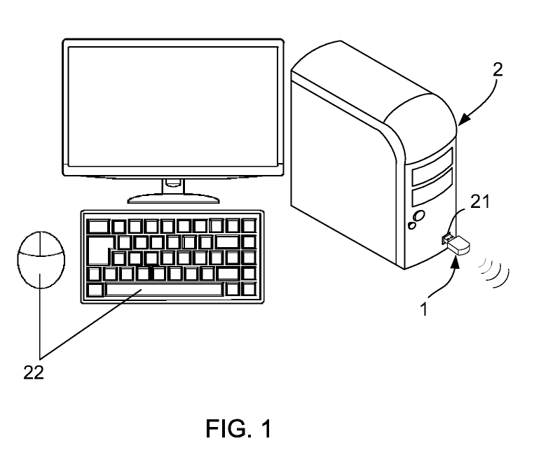

It is well known that USB devices or USB products have been widely used and applied, such as mouse, keyboard, joystick, scanner, digital camera, printer, flash drive, portable external hard drive, optical drive, wireless network card, speaker, and microphone. On the other hand, a particular product integrated with USB and wireless network technologies has also developed and proposed resulted from the usability of USB technology and wireless network technology, such as wireless network care, wireless microphone, wireless mouse, and wireless keyboard. Please refer to FIG. 1, which illustrates a stereo diagram of an USB device integrated with USB and wireless network technologies. As FIG. 1 shows, the USB device 1, an USB dongle having network-connecting capability, is connected to an USB connector 21 of a host electronic device 2. By the disposing of the USB device 1, a bridge connection is established between the wireless mouse/keyboard set 22 (i.e., I/O devices) and the host electronic device 2, such that the wireless mouse/keyboard set 22 become one of the peripheral devices of the host electronic device 2.

The USB device 1 shown in FIG. 1 is an USB-SPI bridge interface, wherein SPI is the abbreviation of serial peripheral interface. Of course, with the development of electronic technologies, USB device 1 does not be limited to be the USB-SPI bridge interface, which can also be an USB-I2C bridge interface, an USB-UART bridge interface, an USB-eMMC bridge interface, an USB-SATA bridge interface, an USB-PATA bridge interface, an USB-I2S bridge interface, an USB-USB bridge interface, an USB-SD bridge interface, or combinations thereof.

The corresponding descriptions for the notations of “I2C”, “UART”, “eMMC”, “SATA”, “PATA”, “I2S”, and “SD” are integrated in following Table (1).

TABLE (1)

| Notation | Description |
|---|---|
| I2C | Inter-Integrated Circuit |
| UART | Universal Asynchronous Receiver/Transmitter |
| eMMC | Embedded Multi Media Card |
| SATA | Serial Advanced Technology Attachment |
| PATA | Parallel Advanced Technology Attachment |
| I2S | Inter-IC Sound |
| SD | Secure Digital Memory Card |

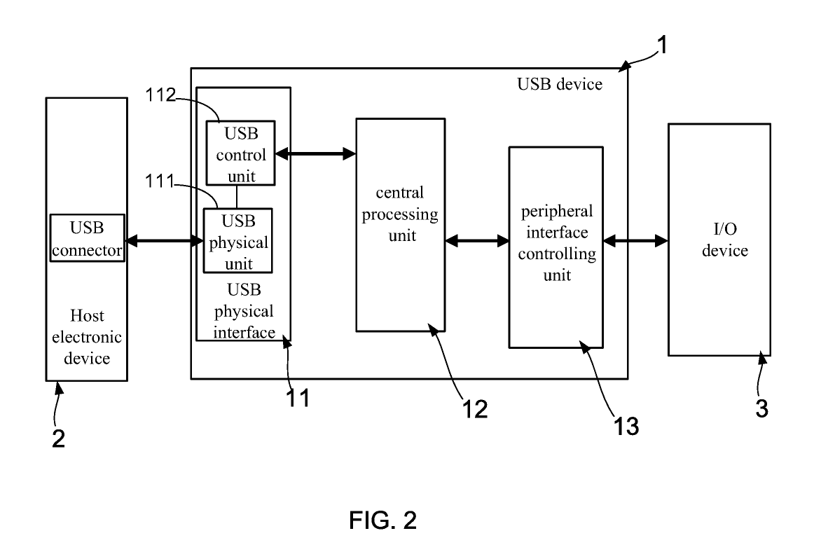

Please refer to FIG. 2, which illustrates a first circuit block diagram of a device capable of automatically identifying host operating system according to the present invention. As FIG. 2 shows, the present invention proposes a device capable of automatically identifying host operating system, wherein the device is an USB device 1 and mainly comprises: an USB physical interface 11, a central processing unit 12, and at least on peripheral interface controlling unit 13. In the present invention, the USB physical interface 11 is used for connecting an USB unit 21 of an external host electronic device 2, wherein the USB physical interface 11 comprises an USB physical unit 111 and an USB control unit 112 embedded with an operating system (OS) identifying module. As engineers skilled in USB produces designing and manufacturing technology field know, the said USB physical unit 111 can be an USB 2.0 connector, an USB 3.0 connector, a mini USB connector, or a micro USB connector.

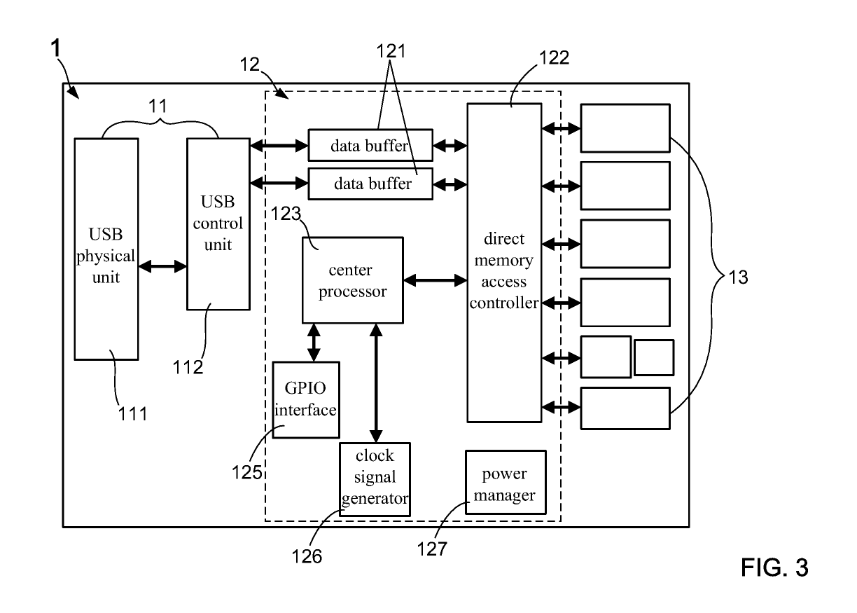

Continuously referring to FIG. 2, and please simultaneously refer to FIG. 3, where a second circuit block diagram of the device capable of automatically identifying host operating system is provided. As FIG. 2 and FIG. 3 show, the central processing unit 12 of the USB device 1 comprises: at least one data buffer 121, a direct memory access controller 122, a center processor 123, a GPIO (general purpose I/O) interface 125, a clock signal generator 126, and a power manager 127.

In the central processing unit 12, the data buffer 121 is coupled to the USB control unit 112 for receiving data outputted by the USB control unit 112. Moreover, the direct memory access controller 122 is coupled to the data buffer 121, the peripheral interface controlling unit 13 and the center processor 123. On the other hand, the center processor 123 is also coupled with the GPIO interface 125 and the clock signal generator 126. By such arrangement, the USB control unit 112 would immediately transmit data to the data buffer 121 when the host electronic device 2 output data to the USB physical unit 111 of the USB physical interface 11. Meanwhile, the power manager 17 provides power to the central processor 123 and the direct memory access controller 122 based on a clock signal outputted by the clock signal generator 125, such that the central processor 123 makes the data buffer 121 transmit the data to the peripheral interface controlling unit 13 through the direct memory access controller 122. Eventually, the peripheral interface controlling unit 13 transmits the data (or signal) to an I/O device connected to the USB device 1 by a specific data transmission protocol.

It is very easy for the engineers skilled in USB product designing and manufacturing technology field to understand that, because the aforesaid I/O device 3 and the USB device 1 shown in FIG. 2 can be respectively equal to the wireless mouse/keyboard set 22 and the USB dongle shown in FIG. 1, the peripheral interface controlling unit 13 is an SPI control interface, reasonably. Of course, for the USB device 1 may be practiced by others form such as an USB-I2C bridge device, an USB-UART bridge device, an USB-eMMC bridge device, an USB-SATA bridge device, an USB-PATA bridge device, an USB-I2S bridge device, an USB-USB bridge device, or an USB-SD bridge, the SPI control interface may be practiced by a corresponding form of I2C control interface, UART control interface, eMMC control interface, SATA control interface, PATA control interface, I2S control interface, SD control interface, USB control interface, and combination thereof.

Particularly, the present invention embeds an operating system (OS) identifying library in the USB control unit 112 of the USB physical interface 11. Therefore, when an operating system installed in the host electronic device 2 treats the USB device 1 with an USB enumeration procedure, the OS identifying library is able to identify the operating system as a first class operating system, a second class operating system, a third class operating system, or a fourth class operating system based on an address setting command sent by the operating system, a device descriptor replied by the USB device 1, a configuration descriptor replied by the USB device 1.

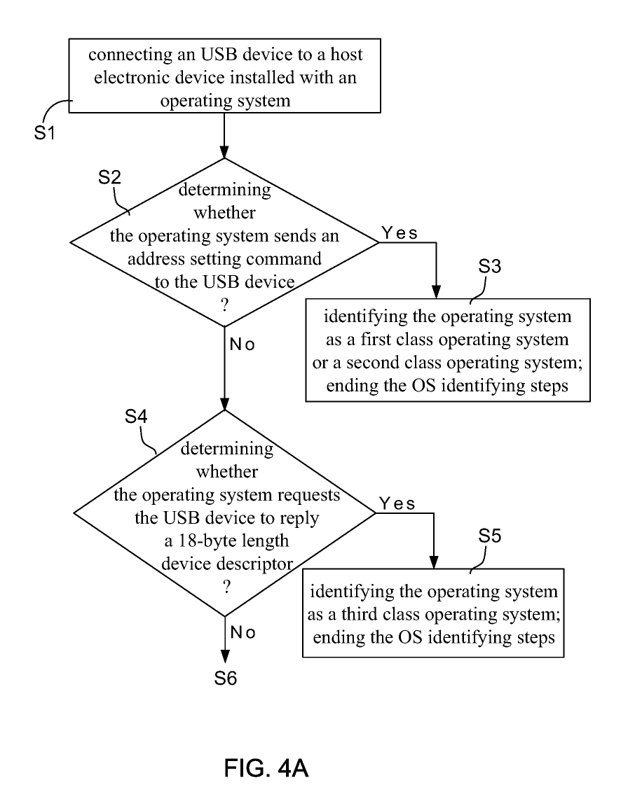

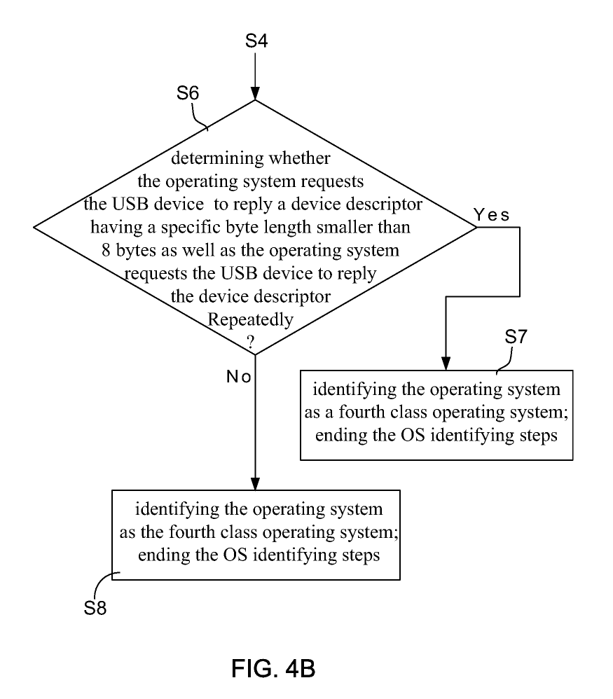

In order to explain the way for the aforesaid OS identifying library embeds in the USB control unit 112 of FIG. 2 to recognize the operating system installed in the host electronic device 2, a method capable of automatically identifying host operating system according to the present invention must be detail introduced. Please refer to FIG. 4A and FIG. 4B, where flow charts of the method capable of automatically identifying host operating system are provided. As FIG. 4A and FIG. 4B show, the method mainly comprises 8 steps.

First of all, the method proceeds to step (S1) for connecting the USB device 1 (shown in FIG. 1 and FIG. 2) to the host electronic device 2 installed with a specific operating system. As the engineers skilled in USB product designing and manufacturing technology field know, the operating system of the host electronic device 2 would treat the USB device 1 with an USB enumeration procedure after the USB device 1 is connected to the host electronic device 2. Meanwhile, the method proceeds to step (S2) for determining whether the operating system sends an address setting command to the USB device. When the determining result of the step (S2) is “yes”, the method would identify the operating system as a first class operating system or a second class operating system, and then end the OS identifying steps (step (S3)). In the present invention the first class operating system and the second class operating system are defined as Apple iOS operating system and Microsoft Windows operating system, respectively.

The step (S3) further comprises 3 following detail steps:
step (S31): determining whether the operating system requests the USB device 1 to reply a configuration descriptor having a specific byte length smaller than 9 bytes, if yes proceeding to step (3S2); otherwise, proceeding to step (S33);
step (S32): identifying the operating system as the Apple iOS operating system, and then proceeding to the ending step;
step (S33): identifying the operating system as the Microsoft Windows operating system, and then proceeding to the ending step.

Referring to FIG. 2, FIG. 4A and FIG. 4B again. When the determining result of the step (S2) is “No”, the method subsequently proceeding to step (S4) for determining whether the operating system requests the USB device to reply a 18-byte length device descriptor. When the determining result of the step (S4) is “Yes”, the method would identify the operating system as a third class operating system (step (S5)). On the contrary, when the determining result of the step (S4) is “No”, the method next proceeds to step (S6) for determining whether the operating system requests the USB device 1 to reply a device descriptor having a specific byte length smaller than 8 bytes as well as the operating system requests the USB device 1 to reply the device descriptor repeatedly. When the determining result of the step (S6) is “Yes”, the method would identify the operating system as a fourth class operating system (step (S7)). On the contrary, when the determining result of the step (S6) is “No”, the method would identify the operating system as the second class operating system (step (S7)).

In the present invention the third class operating system is defined as Apple Mac OS operating system, and the fourth class operating system is defined as Google Android operating system or Linux operating system. Moreover, the step (S8) comprises 3 detail steps for further recognize the version of the said Microsoft Windows operating system is XP, Vista, 7, or 8. The 3 detail steps are listed as follows:
step (S81): determining whether the operating system requests the USB device to reply a configuration descriptor having a specific byte length greater than 9 bytes, if yes proceeding to step (S82); otherwise, proceeding to step (S83);
step (S82): identifying the operating system as the Microsoft Windows Vista operating system, Microsoft Windows 7 operating system, or Microsoft Windows 8 operating system, and then proceeding to the ending step;
step (S83): identifying the operating system as the Microsoft Windows XP operating system, and then proceeding to the ending step.

Therefore, through above descriptions, the method and the device capable of automatically identifying host operating system provided by the present invention has been introduced completely and clearly; in summary, the present invention includes the advantages of:

(1) For the conventionally-used USB devices or USB bridge interfaces cannot effectively identify all kinds of Operation Systems (OS) from an electronic device, the present invention proposes a novel USB device consisting of: a USB physical interface, a central processing unit, and at least one peripheral interface controller; wherein the central processing unit is particularly embedded with an OS identifying library. Moreover, the present invention simultaneously proposes an automatic OS identifying method, which particularly consists of a plurality of OS identifying steps designed based on conventional USB enumeration procedures. Thus, when a specific OS of a host device treats this novel USB device with a USB enumeration, the OS identifying library is able to detect the kind of the specific OS installed in the host device, according to the plurality of OS identifying steps.

The above description is made on embodiments of the present invention. However, the embodiments are not intended to limit scope of the present invention, and all equivalent implementations or alterations within the spirit of the present invention still fall within the scope of the present invention.

What is claimed is:

1. A method capable of automatically identifying host operating system, comprising following steps:
(1) connecting an USB device to a host electronic device installed with an operating system;
(2) determining whether the operating system sends an address setting command to the USB device, if yes, proceeding to step (3); otherwise, proceeding to step (4);
(3) identifying the operating system as a first class operating system or a second class operating system, and then proceeding to an ending step;
(4) determining whether the operating system requests the USB device to reply a 18-byte length device descriptor, if yes, proceeding to step (5); otherwise, proceeding to step (6);
(5) identifying the operating system as a third class operating system, and then proceeding to the ending step;
(6) determining whether the operating system requests the USB device to reply a device descriptor having a specific byte length smaller than 8 bytes as well as the operating system requests the USB device to reply the device descriptor repeatedly, if yes, proceeding back to the step (4); otherwise, proceeding to step (8);
(7) identifying the operating system as a fourth class operating system, and then proceeding to the ending step;
(8) identifying the operating system as the second class operating system, and then proceeding to the ending step.

2. The method of claim 1, wherein the USB device is selected from the group consisting of: mouse, keyboard, joystick, scanner, digital camera, printer, flash drive, portable external hard drive, optical drive, wireless network card, speaker, and microphone.

3. The method of claim 1, wherein the USB device is an USB bridge interface selected from the group consisting of: USB-I2C bridge interface, USB-SPI bridge interface, USB-UART bridge interface, USB-eMMC bridge interface, USB-SATA bridge interface, USB-PATA bridge interface, USB-I2S bridge interface, USB-USB bridge interface, USB-SD bridge interface, and combination thereof.

4. The method of claim 1, wherein the first class operating system is Apple iOS operating system, the second class operating system is Microsoft Windows operating system, the third class operating system is Apple Mac OS operating system, and the fourth class operating system is Google Android operating system.

5. The method of claim 4, wherein the step (3) comprises following detail steps:
(31) determining whether the operating system requests the USB device to reply a configuration descriptor having a specific byte length smaller than 9 bytes, if yes proceeding to step (32); otherwise, proceeding to step (33);
(32) identifying the operating system as the Apple iOS operating system, and then proceeding to the ending step;
(33) identifying the operating system as the Microsoft Windows operating system, and then proceeding to the ending step.

6. The method of claim 5, wherein the step (8) comprises following detail steps:
(81) determining whether the operating system requests the USB device to reply a configuration descriptor having a specific byte length greater than 9 bytes, if yes proceeding to step (82); otherwise, proceeding to step (83);
(82) identifying the operating system as the Microsoft Windows Vista operating system, Microsoft Windows 7 operating system, or Microsoft Windows 8 operating system, and then proceeding to the ending step;
(83) identifying the operating system as the Microsoft Windows XP operating system, and then proceeding to the ending step.

7. A device capable of automatically identifying host operating system, comprising:
an USB physical interface, being used for connecting an USB unit of an external host electronic device; wherein the USB physical interface comprises an USB physical unit and an USB control unit embedded with an operating system (OS) identifying module;
a central processing unit, being coupled to the USB physical interface; and
at least on peripheral interface controlling unit, being coupled to the central processing unit;
wherein when an operating system installed in the host electronic device treats the USB device with an USB enumeration procedure, the OS identifying module being able to identify the operating system as a first class operating system, a second class operating system, a third class operating system, or a fourth class operating system based on an address setting command sent by the operating system, a device descriptor replied by the USB device, a configuration descriptor replied by the USB device.

8. The device of claim 7, wherein the USB device is an USB bridge interface selected from the group consisting of: USB-I2C bridge interface, USB-SPI bridge interface, USB-UART bridge interface, USB-eMMC bridge interface, USB-SATA bridge interface, USB-PATA bridge interface, USB-I2S bridge interface, USB-USB bridge interface, USB-SD bridge interface, and combination thereof.

9. The device of claim 7, wherein the first class operating system is Apple iOS operating system, the second class operating system is Microsoft Windows operating system, the third class operating system is Apple Mac OS operating system, and the fourth class operating system is Google Android operating system.

10. The device of claim 7, wherein the USB physical unit of the USB physical interface is selected from the group consisting of: USB 2.0 connector, USB 3.0 connector, mini USB connector, and micro USB connector.

11. The device of claim 9, wherein the central processing unit comprises:
at least one data buffer, being coupled to the USB control unit, for receiving data outputted by the USB control unit;
a direct memory access controller, being coupled to the data buffer and the peripheral interface controlling unit;
a center processor, being coupled to the direct memory access controller;
a GPIO (general purpose I/O) interface, being coupled to the central processor;
a clock signal generator, being coupled to the central processor; and
a power manager, wherein the power manager provides power to the central processor and the direct memory access controller based on a clock signal outputted by the clock signal generator, such that the central processor makes the data buffer transmit the data to the peripheral interface controlling unit through the direct memory access controller.
